(19) United States
(12) Patent Application Publication
(10) Pub. No.: US 2014/0359718 A1
(43) Pub. Date: Dec. 4, 2014

(54) SYSTEM FOR MANAGING THE USE OF PREMISES

(71) Applicants: Jari Turunen, Espoo (FI); Heli Etuaro, Helsinki (FI); Juha Luotio, Espoo (FI); Tuomas Tolvanen, Vantaa (FI)

(72) Inventors: Jari Turunen, Espoo (FI); Heli Etuaro, Helsinki (FI); Juha Luotio, Espoo (FI); Tuomas Tolvanen, Vantaa (FI)

(21) Appl. No.: 14/344,243

(22) PCT Filed: Sep. 14, 2012
(86) PCT No.: PCT/FI2012/050889

§ 371 Date: Mar. 11, 2014

(30) Foreign Application Priority Data
Sep. 16, 2011 (FI) 20115911

(51) Int. Cl. H04L 29/06; H04W 4/00; H04L 29/08

(52) U.S. Cl. CPC H04L 63/08; H04L 67/18; H04W 4/008
USPC 726/4

(57) ABSTRACT

The system has monitoring devices, a control unit, a personal identifier for each user, and a remote server which includes a premises-management software stored in a memory device. At least some of the monitoring devices are provided with a router. Monitoring devices are connected to the control unit, and monitoring devices provided with a router are further connected to each other. The control unit is connected to the remote server via the internet. A user may log in as the user of a workstation with the help of the identifier in the monitoring device. With the help of the terminal, the user may also sign in to the management software, from which he can see the state of the workstations and reserve a vacant workstation for himself.

### TECHNICAL FIELD

The present invention relates to a system according to claim 1 for managing the use of premises.

The invention also relates to a system according to claim 6 for administrating the use of premises.

### PRIOR ART

U.S. Pat. No. 7,978,082 discloses a method and a device for locating persons based on the RFID technology. The system comprises a terminal, e.g. a computer or a smart phone, for a person to be followed, e.g. a home aid, which terminal includes an RFID reader and an RFID identifier at a customer's, e.g. an elderly person's, home. When the home aid arrives at the customer's house, he performs a scanning of a first RFID identifier with the terminal's RFID reader, and when the home aid leaves the site, he performs a scanning of a second RFID identifier. Each reading is stored in the terminal, from which it can be transferred to a database in the server e.g. at the end of the day. A code identifying the home aid, a code identifying the customer as well as the home aid's time of arrival and departure are thus stored in the database. By this means the home aid's visits to the customer's house can be tracked.

Furthermore, there are different sorts of solutions on the market for controlling the use of premises from a cost aspect. One example of a solution applicable for controlling the costs of the premises is the Optimaze.net software developed by the applicant. The Optimaze.net software includes basic information about each premise, such as the location of the premises (country, area, building, floor), layout of the premises with the coordinate information etc. Moreover, the software includes cost information about the premises, such as investment, rent, electricity, water, cleaning etc. Optimaze.net provides a browser-based user interface, wherein the user may use the software anywhere, as long as he has an access to a terminal that is connected to the internet. The Optimaze.net software may be used in dividing costs between different operators. This division may be done between different departments of the company, for instance. The cost information related to the company's property expenses is entered in the Optimaze.net software from the company's financial administration system, and the Optizame.net software divides these costs between the departments. For instance the layouts of the premises, information about the company's employees etc. are used in dividing the costs. In regards of common facilities and conference rooms, suitable coefficients are used, by which costs are divided between the users of the premises.

However, there are not any efficient solutions available on the market for controlling the use of premises from an efficiency aspect.

### SUMMARY OF THE INVENTION

The object of the invention is to create a new and efficient method for managing the use of premises from an efficiency aspect.

The characteristic features of the system according to the invention are disclosed in the characterizing part of claim 1.

The characteristic features of the method according to the invention are disclosed in the characterizing part of claim 6.

The system comprises:
monitoring devices comprising at least a transmitter/receiver module and a sensor module, wherein at least each workstation includes a monitoring device, and wherein at least some of the monitoring devices further comprise a router,
a control unit comprising at least a transmitter/receiver module,
a personal identifier for each user,
a remote server including a premises management software stored in a memory device, wherein the control unit is connected to the remote server via the internet.

By using a personal identifier, a user may log in to the monitoring device that sends the log-in data to the premises management software in the remote server via the control unit, in which management software the user's status is updated accordingly.

On the other hand, the user may log in via a terminal to the premises management software in the server, in which management software he can see the state of the workstations and reserve a vacant workstation for himself.

The system according to the invention enables an efficient management of the premises' workstations. Especially the use of conference rooms and other freely bookable workstations can be made more efficient with the help of the system. The premises may include workstations reserved fixedly for certain people, as well as freely bookable workstations. For instance people working in the sales department may reserve a workstation from the freely bookable workstations when they need one. The company may have premises in different locations, for instance in Helsinki, Turku, Tampere and Oulu, in which case a user may reserve a workstation from any premises. E.g. a person working normally in Helsinki may reserve a workstation from the Oulu office during his business trip.

The workstation's state information and the users' status information are shown in real time in the management software in the remote server. When a user reserves a workstation, the state information of that workstation changes from ‘vacant’ to ‘reserved’. When the user subsequently logs in to the workstation, the state information of that workstation changes from state ‘reserved’ to state ‘occupied’. The user may also select the state ‘do not disturb’ from the monitoring device's keyboard. When the user is logged off from the workstation, the state information of that workstation is updated from state ‘occupied’ to state ‘reserved’ or ‘vacant’, depending on whether or not the workstation is fixedly reserved for that user.

A user may have reserved for instance the conference room of the workstation from the management software for three hours on a set day, but the negotiation only lasts for one hour. When the user frees the conference room after an hour, the state information of that conference room changes from state ‘occupied’ to state ‘vacant’ in real time in the management software.

On the other hand, a user may have reserved e.g. his own office permanently for himself in the management software. When the user signs in via his office's monitoring device, the state of the workstation changes from state ‘reserved’ to state ‘occupied’. When the user signs out via the monitoring device located in the premises' common facilities, the state of the workstation changes from state ‘occupied’ to state ‘reserved’. If the user for example leaves on vacation or a business trip, he may change his office's ‘reserved’ state to state ‘vacant’ for the duration of his vacation or business trip with the help of the management software.

Different kinds of illustrating graphics related to the efficiency of use of the premises may be created with the help of the system. From the premises management software in the remote server one can select for instance a location display, which shows the layout of the premises as well as the names of the persons working at different workstations, and also their pictures, if desired. The workstation types, i.e. a workstation in an open space, a quiet room or a conference room, are shown in different colors, whereby the overall situation of the premises can be easily conceived. One can also easily locate different people from this display. Furthermore, one can produce different kinds of reports on the efficiency of the use of the premises for instance on a monthly, daily or hourly level, etc. With the help of real-time monitoring of the use of premises one gains valuable ground information, on the basis of which plans may me made on how to make the use of premises more efficient.

### BRIEF DESCRIPTION OF FIGURES

In the following, some preferred embodiments of the invention are described by referring to the enclosed figures.

FIG. 1 shows a diagram of a system according to the invention in a building.

FIG. 1 shows a diagram of a system on one floor of the building.

FIG. 3 shows a diagram of a monitoring device suitable to be used in the system.

FIG. 4 shows a diagram of a user's identifier suitable to be used in the system.

FIG. 5 shows a diagram of a control unit suitable to be used in the system.

FIG. 6 shows a diagram of the operation of the system according to the invention.

### DESCRIPTION OF PREFERRED EMBODIMENTS

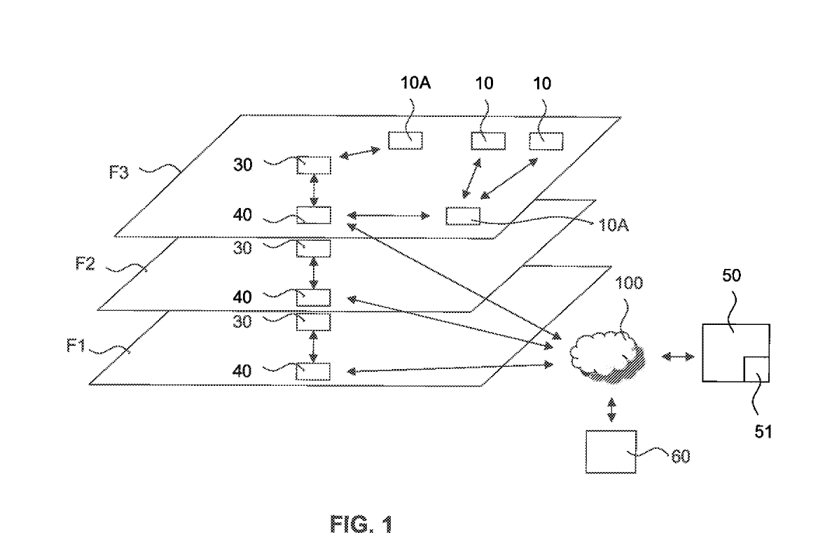

FIG. 1 shows a diagram of a system according to the invention in a building that comprises three floors F1-F3. FIG. 2, on the other hand, discloses a diagram of the system on the floor three F3 of the building.

All floors F1-F3 include premises with workstations. Each workstation may consist of e.g. a workstation in an open space T1 or a quiet room T2 or a conference room T3. The facilities on the third floor F3 form one premises herein.

The system comprises monitoring devices 10, 10A, routers 20, a control unit 30 and a remote server 50. Some of the monitoring devices 10 do not include a router 20 and some of the monitoring devices 10A do include a router. A determined number of monitoring devices 10 not including a router 20 is arranged within the scope of each monitoring device 10A including a router 20. All monitoring devices 10 not provided with a router 20 within the scope of each monitoring device 10A provided with a router 20 therefore form group R1. Within the scope of the monitoring device 10A including a router 20 there is thus a determined number of monitoring devices 10 not including a router 20. Each monitoring device 10 belonging to a determined group R1 is in data transmission contact with that group's monitoring device 10A provided with a router, and each monitoring device 10A provided with a router 20 is in data transmission contact with all the other monitoring devices 10A provided with a router 20 and the control unit 30. The control unit 30 is, on the other hand, in data transmission contact with the computer 40, and the computer 40 is connected to the remote server 50 via a data transmission link via the internet 100. The remote server 50 may be located far from the building including the premises, for instance in the service provider's premises.

Monitoring devices 10, 10A are located in connection with at least each workstation T1, T2, T3 of each floor F1-F3. A commercial, wireless network according to standard IEEE 802.15.4 sold with the ZigBee® brand is used in the embodiment disclosed in the figures. The ZigBee technique supports the mesh network in which each monitoring device 10 not including a router 20 is in contact with that group's monitoring device 10A provided with a router 20. Monitoring devices 10A provided with a router 20 are, on the other hand, in contact with each other and with the monitoring device 30. Each group's monitoring devices 10 without a router only communicate with their own group's monitoring device 10A provided with a router 20, whereas the monitoring devices 10A provided with a router 20 communicate with each other and with the control unit 30. Groups R1 consist of monitoring devices 10 without a router 20 so that monitoring devices 10 of each group R1 are connected by means of a wireless data transmission link to that group's R1 monitoring device 10A provided with a router 20. Routers 20 are therefore physically connected to the monitoring devices 10A that control the groups R1.

Each device connected to the ZigBee network, i.e. the monitoring device 10, 10A and the control unit 30, has a unique address, on the basis of which the location of each device in the ZigBee network can be determined unambiguously. In addition to the aforementioned devices, also other devices can be connected to the ZigBee network. For instance the power supply and/or the lighting of the workstation may be controlled via the ZigBee network. For instance, the power may not come on until the user signs in to the monitoring device 10, 10A, wherein the electric switch has been formed into a device in the ZigBee network. In a corresponding manner, for instance the lighting of the workspace's conference room T3 may be controlled with an electric switch that is part of the ZigBee network. The computer 40, which is preferably a PC, picks up events of the devices connected to the ZigBee network and forwards them to the premises management software in the remote server 50. In a corresponding manner, the computer 40 transmits the messages of the premises management software to the ZigBee network's devices. The control unit 30 is connected to the computer 40 via a wireless data transmission link.

The computer 40 is not indispensable, as the monitoring device 30 may also be connected directly to the remote server 50 via the internet 100. Instead of the computer 40, a control device 30 may be connected to a mobile phone, i.e. a smart phone, via which the communication with the remote server 50 takes place. The ZigBee network can also be built so that all monitoring devices 10A include a router 20. In that case all monitoring devices 10A are in data transmission connection with each other and the control device 30.

The management software in the remote server 50 can be built in connection with the Optimaze.net software developed by the applicant. The Optimaze.net system was already described in the part describing the prior art of this application.

The user may log in to the premises management software in the server 50 with the help of terminal 60. The terminal 60 may be for instance a workstation provided with a browser, a portable computer or a ThinClient terminal that is connected to the internet 100. The user may thus use the premises management software of the server 50 stored in the memory device 51 anywhere, as long as he has an access to a terminal provided with a browser and connected to the internet.

Alternatively, the terminal 60 may also be a mobile phone i.e. a smart phone. A user thereby logs in to the premises management software in the server 50 with the help of a software application in his mobile phone. The mobile phone is in data transmission contact with the premises management software in the server 50 via a mobile telephone network and the internet 100.

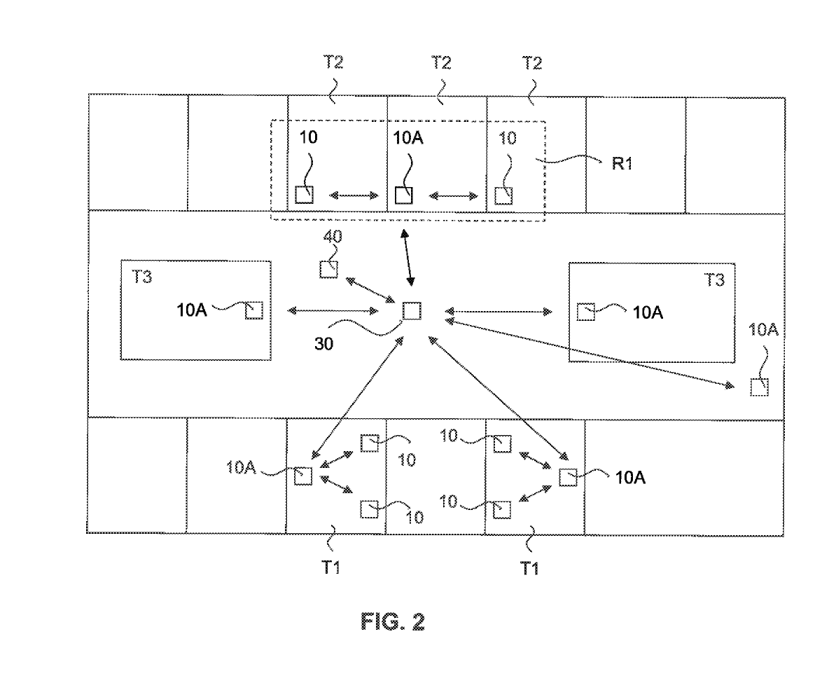

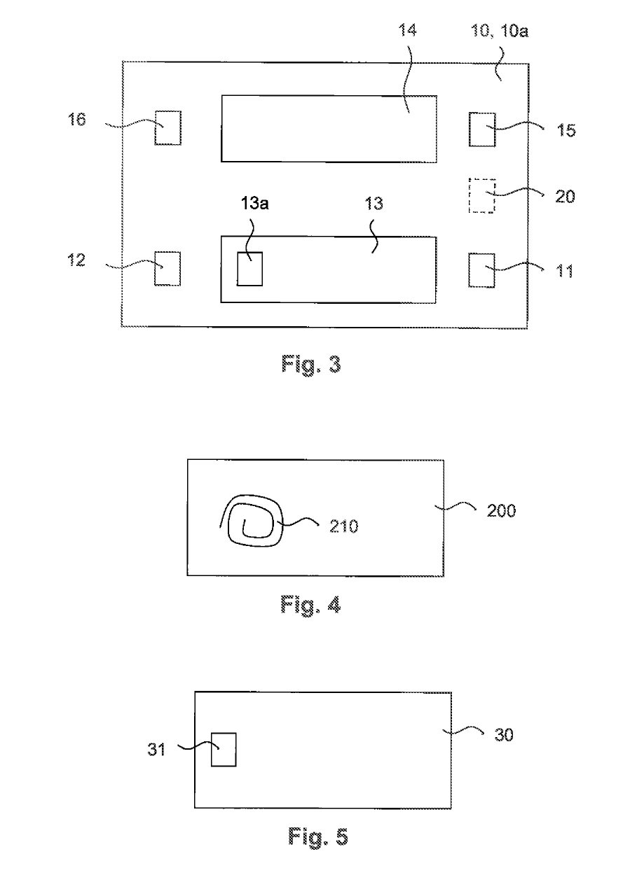

FIG. 3 shows a diagram of a monitoring device suitable to be used in the system. The monitoring device 10 10A comprises here a transmitter/receiver unit 11, s sensor module 12, i.e. an RFID reading device, a keyboard 13 and a display device 14. The display device 14 may consist of a display or lamps, e.g. LED lamps. By means of the display, information is transmitted in a more versatile manner compared to the lamps, but the state of the workstation may also be indicated with the lamps only. The keyboard 13 may consist of individual push buttons or a larger keyboard. The keyboard 13 of the monitoring device 10, 10A comprises here merely the ‘do not disturb’ button 13a. A temperature sensor 15 and a voltage measuring circuit 16 may also be placed in the monitoring device 10, 10A. Temperature data and voltage data may be transferred from the monitoring device 10, 10A to the premises management software in the server 50. Voltage data is important especially when the monitoring device 10, 10A is battery-driven. The management software may direct the monitoring device 10, 10A to display this data on the display 14. Furthermore, the management software may direct the monitoring device 10, 10A to display the time on the display 14. The monitoring devices 10A that are responsible for data transmission traffic outside group R1, further include a router 20. The monitoring device 10, 10A is simple and reliable and it has low manufacturing costs.

FIG. 4 shows a diagram of a user's identifier based on the RFID technique. In this application the RFID identifier 200 consists of a preferably passive RFID identifier having a mesh 210 that is read with an external RFID reading device. A passive RFID identifier is inexpensive and reliable. The user takes his RFID identifier relatively close to the RFID reader 12 of the monitoring device 10, which RFID reader identifies the user and sends a message to the remote server 50 which registers that user as the user of that particular workstation. Logging in to the workstation is thereby reliable.

FIG. 5 shows a diagram of a monitoring unit suitable to be used in the system. The control unit 30 comprises at least a transmitter/receiver module 31, via which the control unit 30 is in contact with the routers 20, 20A as well as with the management software in the remoter server 50 via the internet 100.

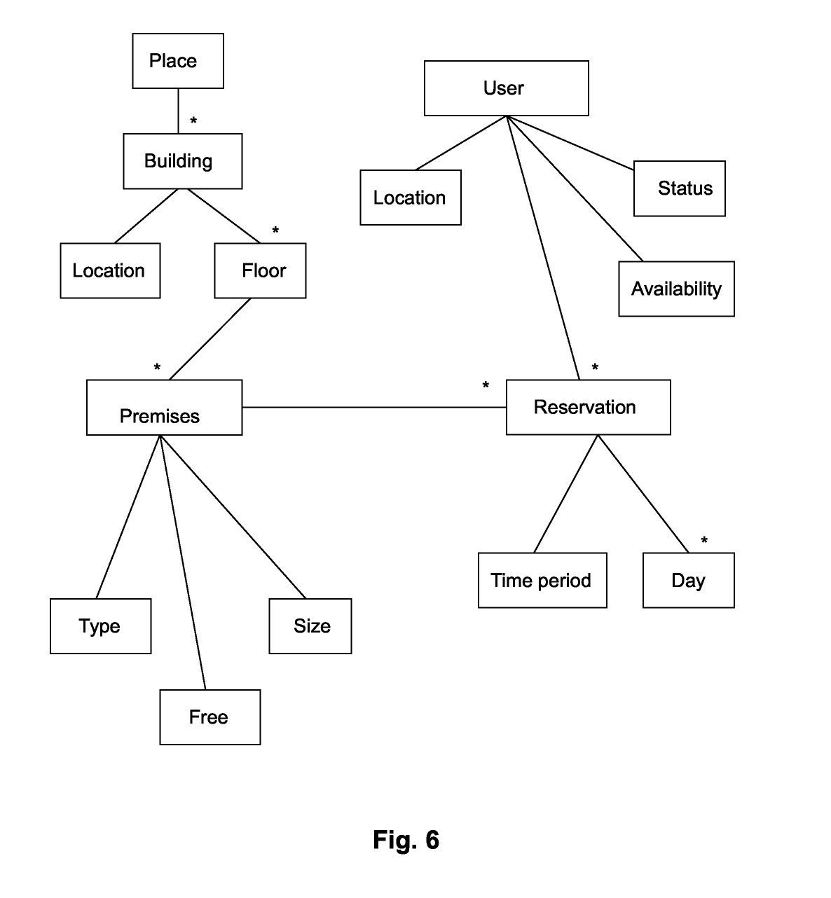

FIG. 6 shows a diagram of the operations of a system according to the invention. The use of the system is based on the Optimaze.net system used with the help of the terminal 60. The figure discloses a situation in which a user contacts the Optimaze.net system in the remote server 50 with the terminal 60, which in this case is a mobile phone, i.e. a so-called smart phone. A line means that two concepts are related to each other, and an asterisk refers to a ‘one-to-many’ connection.

When the user logs in to the Optimaze.net system via his mobile phone, the first main window i.e. the status page opens up. The user selects his own status and availability from the status page. The status may be for instance ‘at the office’, ‘at a customer’, ‘in a telephone conference’ or ‘absent’, and the availability may be expressed for instance with two states, ‘available’ and ‘do not disturb’. Furthermore, the mobile phone includes a GPS application, which shows the user's location.

The next main window is the reservation page. On this page the user may select the type of facility, i.e. a workstation in an open space, a quiet room or a conference room.

When a user wishes to reserve a workstation, he first chooses the day and the period of time as well as the desired facility type, i.e. a quiet room or all workstations. After doing so, the software displays a list of places sorted out so that the places closest to the user come first, as calculated on the basis of the user's mobile phone's current GPS location. The distance to each place is also shown on the display. When the place is selected, the buildings related to that place are shown so that the closest one is the first on the list. When the building is selected, the floors in that building are displayed. When the floor is selected, the facilities on that floor are displayed. When the facility is selected, the device displays all the information of that facility as well as a push button, from which the facility may be reserved for the day and period of time initially selected. A facility with no available workstations can be opened, but it is displayed in a dimmed manner and it does not have a reservation button.

When the user wishes to reserve a conference room, he selects the minimum number of seats he needs, whereby only the conference rooms fulfilling that criteria are displayed. Next, the software displays a list of all places sorted out in a manner described above. After this the place, building, floor and facility are selected. Once the facility, i.e. the conference room, has been selected, the reservation is confirmed with the push button.

The system's operation in a situation where the terminal is a workstation, e.g. a PC, corresponds for the most part to the description above based on a mobile phone application. The above disclosed mobile phone application is chiefly based on a smart phone provided with a Windows 7 operating system. Using the same principles, the mobile phone application may of course be directed to a mobile phone using other operating systems as well, such as for instance Android or iPhone.

A work community may use one premises in one single building, several premises in one single building, several premises in different buildings, several buildings in different places etc. A premises cloud comprising all premises of one work community may be established in the Optimaze.net system. On the other hand, a premises cloud comprising the premises of several work communities can also be established in the system, wherein all or some workstations of the premises cloud may be shared between a number of different work communities. When a user reserves a workstation, the reservation can be seen in the Optimaze.net system as well as on the display 14 of the monitoring device 10, 10A in connection with the workstation in question.

When the user arrives at the workstation T1, T2, T3, he signs in as the user of the workstation by taking his RFID identifier near the RFID reading device 12 in the monitoring device 10. The reading device 12 reads the user's identification data from the RFID identifier and sends a message to the management software in the remoter server 50, which management software registers the user in question as the user of that workstation. The workstation in question becomes vacant for example when the user goes home and takes his RFID identifier near the RFID reading device of the router 20A e.g. in the vicinity of the front door in the common facilities of the premises and selects the ‘out’ mode from it, or when the user signs in to another workstation. The state of the workstation, e.g. ‘reserved’, ‘occupied’, ‘vacant’, ‘do not disturb’, can be seen in real time in the Optimaze.net system and on the display device 14 of the monitoring device 10, 10A.

The above mentioned system can be connected to a time tracking software. When a user arrives at his workstation in the morning, he signs in to the workstation, whereby he is registered as ‘present’ in the time tracking software. When the employee goes off for a lunch, he clocks himself in and out with his identifier in the monitoring device located next to the premises' front door. When the employee goes home at the end of the day, he clocks himself out in the same monitoring device located next to the premises' front door. The state of his workstation changes in connection with the clock-out. If the workstation is the user's standard workstation, the state of the workstation changes from state ‘occupied’ to state ‘reserved’, and under other circumstances the state of the workstation changes from state ‘occupied’ to state ‘vacant’.

The system has been described above with the help of the ZigBee network and RFID identifier. This is an affordable and functioning solution, but the system may also be executed by means of some other network and identifier. The user identification at the workstation may take place e.g. with the help of a camera or a biometric identifier, such as a finger print. The ZigBee network may be replaced by some other wireless network having corresponding data transmission features. The interface via which some other network than the ZigBee network may communicate with the remote server, is determined for the control device. A user may, for instance, have an active RFID identifier that communicates with the monitoring device automatically when the user is close enough to the first terminal. The user thereby automatically registers to the monitoring device at his work station. An automatic log-in involves a risk of mis-logging. Especially in situations where the workstations are near each other, the user may accidentally log in to a wrong work station.

The invention is not restricted to the embodiments disclosed in the figures, as numerous variations may be made to them within the scope of the enclosed claims.

We claim:

1. A system for managing the use of premises, comprising,
monitoring devices comprising at least a transmitter/receiver module and a sensor module, wherein there is a monitoring device in connection with at least each workstation,
a control unit, comprising at least a transmitter/receiver module,
a personal identifier for each user,
a remote server having a premises management software stored in a memory device, wherein the control unit is connected to the remote server via the internet,
wherein the user logs in with the help of the terminal to the premises management software in the server, from which management software he sees the state of the workstations and reserves a vacant workstation for himself, at least one of the monitoring devices further comprises a router, wherein groups (R1) have been formed of the monitoring devices not including a router under one monitoring device provided with a router, wherein each monitoring device not including a router in a determined group (R1) is connected via a data transmission link to that group's (R1) monitoring device provided with a router, which monitoring device provided with a router is connected via a data transmission link to the control unit and each other monitoring device provided with a router, and the control unit is in contact with the routers via the transmitter/receiver module,
wherein the user signs in with his personal identifier to the monitoring device which sends the log-in data via the control unit to the premises management software in the remote server in which management software the user's status is updated accordingly.

2. A system according to claim 1, wherein the monitoring device further comprises a display device, via which the state of the workstation and possibly some other information related to the system can be transmitted to the user.

3. A system according to claim 1 wherein the sensor module of the monitoring device consists of an RFID reading device and that the user's personal identifier consists of a passive RFID identifier.

4. A system according to claim 1 wherein each monitoring device includes a router, wherein each monitoring device is in data transmission contact with each other monitoring device and the control unit.

5. A method for managing the use of premises, in which method the user signs in with the help of the terminal to the premises management software in the server, from which management software he sees the state of the workstations and reserve a vacant workstation for himself, comprising,
a user logs in with his personal identifier to the monitoring device in connection with the workstation which monitoring device reads the identification data from the identifier and sends the identification data to the premises management software in the server via the control unit wherein the user in question is registered as the user of that workstation in the premises management software,
and when the user is logged out from the workstation via the monitoring device, the workstation's state information changes from state ‘occupied’ to state ‘vacant’,
wherein the management software in the server is used to produce different kind of real-time information about the efficiency of the use of the premises' workstations.

6. A method according to claim 5, wherein freeing the workstation takes place when the user takes his identifier near the reading device of the router's identifier located in the common facilities of the premises and selects the ‘out’ mode from it.

7. A method according to claim 5, wherein freeing the workstation takes place when the user signs in to another workstation.

8. A method according to claim 5, wherein the system is connected to a time tracking software, wherein the state of the workstation changes in connection with the employee's clock-ins and clock-outs done with the help of the user's identifier.
